(19) United States
(12) Patent Application Publication
(10) Pub. No.: US 2025/0190378 A1
(43) Pub. Date: Jun. 12, 2025

(54) MEMORY EXPANDER, ELECTRONIC DEVICE INCLUDING THE MEMORY EXPANDER AND METHOD OF OPERATING THE ELECTRONIC DEVICE

(71) Applicant: Samsung Electronics Co., Ltd., Suwon-si (KR)

(72) Inventors: Hyunseok Kim, Suwon-si (KR); MYUNGKYU LEE, Suwon-si (KR); KIJUN LEE, Suwon-si (KR)

(21) Appl. No.: 18/963,602

(22) Filed: Nov. 28, 2024

(30) Foreign Application Priority Data
Dec. 12, 2023 (KR) 10-2023-0179739
May 30, 2024 (KR) 10-2024-0071137

(51) Int. Cl. G06F 13/16; G06F 12/02; G06F 13/42

(52) U.S. Cl. CPC G06F 13/1668; G06F 12/0246; G06F 13/4221

(57) ABSTRACT

A memory expander, an electronic device including the memory expander, and a method of operating the electronic device are provided. The memory expander includes a controller configured to perform a compression operation on data received from outside of the memory expander to generate compressed data and generate mapping data including a device physical address for the compressed data, and a first memory device including a volatile memory that is connected to the controller through a first channel and includes a first mapping data region where the mapping data is stored and a first compressed data region where the compressed data is stored.

### CROSS-REFERENCE TO RELATED APPLICATION

This application claims priority to and the benefit of Korean Patent Application No. 10-2023-0179739 filed in the Korean Intellectual Property Office on Dec. 12, 2023, and Korean Patent Application No. 10-2024-0071137 filed in the Korean Intellectual Property Office on May 30, 2024, the entire contents of each of which are incorporated herein by reference.

### BACKGROUND OF THE INVENTION

### (a) Field of the Invention

The present disclosure relates to a memory expander, an electronic device including the memory expander, and a method of operating the electronic device.

### (b) Description of the Related Art

The size of data processed in modern computing systems is increasing exponentially with the widespread use of data-intensive tasks such as large-scale databases. The data-intensive tasks require a large amount of memory in computing systems to quickly process and analyze large amounts of data.

In order to use a large amount of memory in a computing system, it is important to overcome the hardware limitations of the processor and the phenomenon of memory overprovisioning. To overcome these problems, Compute express Link (CXL) interconnect technology, which efficiently connects various peripheral devices, is being proposed.

Through the CXL interconnect technology, technologies used in the existing processor-based memory are being distributed to peripheral devices.

### SUMMARY OF THE INVENTION

The present disclosure describes a memory expander and electronic device capable of improving a physical overhead required for a channel by efficiently allocating a data region.

The present disclosure describes a memory expander and electronic device capable of improving read operation efficiency of compressed data by efficiently allocating a data region.

According to an embodiment, a memory expander includes a controller configured to perform a compression operation on data received from outside of the memory expander to generate compressed data and generate mapping data including a device physical address for the compressed data, and a first memory device including a volatile memory that is connected to the controller through a first channel and includes a first mapping data region where the mapping data is stored and a first compressed data region where the compressed data is stored.

According to another embodiment, an electronic device includes a processor configured to generate a confirmation request requesting memory capacity information and a compression request for a host physical address and data of the host physical address, and provide the confirmation request and the compression request through a CXL interface, and a memory expander including a memory device and configured to: provide memory capacity information corresponding to a first region of the memory, which is some of the overall memory capacity of the memory device, to the processor in response to the confirmation request provided from the processor, and generate compressed data for the data and mapping data including the host physical address in response to the compressed request. The memory device is a DRAM in which the compressed data and the mapping data are stored.

According to still another embodiment, a method of operating an electronic device includes providing a confirmation request requesting memory capacity information to a memory expander including a dynamic random-access memory (DRAM), providing memory capacity information corresponding to a first region, which is part of a memory device included in the memory expander, to a processor in response to the confirmation request, allocating a compressed data region and an uncompressed data region within the first region, generating compressed data and mapping data including a host physical address in response to a compression request for data from the processor, and performing a write operation on the compressed data in the compressed data region and performing a write operation on the mapping data in a second region different from the first region within the memory device.

### BRIEF DESCRIPTION OF THE DRAWINGS

FIG. 1 is a block diagram illustrating an electronic device according to an exemplary embodiment.

FIG. 2 is a block diagram illustrating the electronic device of FIG. 1 in greater detail.

FIG. 3 is a ladder diagram illustrating an initialization operation or power-up operation of the electronic device of FIG. 2.

FIG. 4 is an exemplary diagram illustrating header information of an operation request of FIG. 3.

FIG. 5 is a block diagram illustrating a controller of a memory expander according to one exemplary embodiment.

FIG. 6 is a diagram for describing mapping data according to an exemplary embodiment.

FIG. 7 is a diagram for describing a memory expander according to an exemplary embodiment.

FIG. 8 is a diagram describing a plurality of banks in a memory device according to an exemplary embodiment.

FIG. 9 is a flowchart illustrating a method of operating an electronic device according to an exemplary embodiment.

FIG. 10 is a ladder diagram illustrating a method of operating an electronic device according to an exemplary embodiment.

FIG. 11 is a diagram for describing a method of operating an electronic device according to an exemplary embodiment.

FIG. 12 is a diagram describing a plurality of banks in a memory device according to an exemplary embodiment.

FIG. 13 is a ladder diagram illustrating a method of operating an electronic device according to an exemplary embodiment.

FIG. 14 is a diagram for describing a memory expander according to an exemplary embodiment.

FIG. 15 is a block diagram illustrating an electronic device according to an exemplary embodiment.

FIG. 16 is a block diagram illustrating a computing system to which a memory system according to an exemplary embodiment is applied.

FIG. 17 is a block diagram illustrating a data center to which a memory system according to an exemplary embodiment is applied.

### DETAILED DESCRIPTION OF THE EMBODIMENTS

Hereinafter, exemplary embodiments of the present disclosure will be described in detail with reference to the accompanying drawings so that those skilled in the art to which the present invention pertains may easily practice the present invention. However, the present invention may be implemented in various different forms and is not limited to exemplary embodiments provided herein.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first”) in a particular claim may be described elsewhere with a different ordinal number (e.g., “second”) in the specification or another claim.

Similar components will be denoted by the same reference numerals throughout the present specification.

In addition, unless explicitly described to the contrary, the word “comprise”, and variations such as “comprises” or “comprising”, will be understood to imply the inclusion of stated elements but not the exclusion of any other elements.

In addition, even if explicitly recited within the claim, specific numbers stated in the claim should not be construed as limiting the specific number in claims where such citation does not exist.

Moreover, when conventions such as ‘at least one of A, B, or C’ are used, such syntax will be well understood by a person well versed in the art (for example, “a system containing at least one of A, B, or C” means A alone, B alone, C alone, A and B, A and C, B and C, or A, B, and C together). Alternatively, letters and/or phrases in the description, claims, or drawings that have two or more separate selectable terms should be considered as likely to include one, either, or both terms. For example, the phrase ‘A or B’ should be understood as including the possibilities ‘A’, or ‘B’, or ‘A and B’.

The terms such as “module,” “unit,” and “part” used in the present document are terms used to refer to components that perform at least one function or operation, and these components may be implemented in hardware or software or implemented as a combination of hardware and software, such as by a processor that executes computer program code stored on a tangible, computer-readable medium.

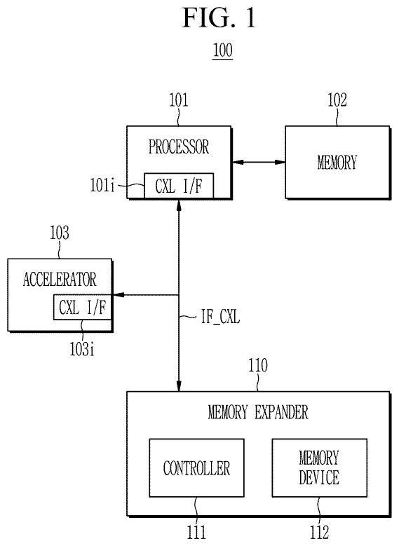

FIG. 1 is a block diagram illustrating an electronic device according to an exemplary embodiment.

Referring to FIG. 1, an electronic device 100 may include a processor 101, a memory 102, an accelerator 103, and a memory expander 110. According to an exemplary embodiment, the electronic device 100 may be a heterogeneous computing device or a heterogeneous computing system. A heterogeneous computing system may be a system in which different types of computing devices are organically connected to each other to perform various functions. For example, as illustrated in FIG. 1, the processor 101 and the accelerator 103 may be different types of computing devices. However, according to an exemplary embodiment, the electronic device 100 may be a computing system classified as a particular type of computing device, even if it is formed of a plurality of different types of computing devices.

The processor 101 may be a processor core that controls overall operations of the electronic device 100. According to an exemplary embodiment, the processor 101 may include a central processing unit, etc., and may be a multi-core processor including a plurality of process cores. The processor 101 is a host device and can process data by interpreting commands of an operating system or various programs running on the electronic device 100.

The processor 101 may communicate directly with the memory 102, and data processed by the processor 101 or data required during operation of the processor 101 may be stored in the memory 102. The memory 102 may be used as a buffer memory, a cache memory, or a system memory for processor 101. According to an exemplary embodiment, the memory 102 may be Double Data Rate Synchronous DRAM (DDR SDRAM), Low Power DDR (LPDDR) SDRAM, Graphics DDR (GDDR) SDRAM, Rambus DRAM (RDRAM), or High Bandwidth Memory (HBM), and may be a dual in-line memory module (DIMM)-based memory.

According to an exemplary embodiment, the processor 101 may manage a system memory including at least a portion of the memory 102 and the memory expander 110, including a memory management unit, a memory protection unit, etc. The processor 101 may include a compute express link (CXL) interface 101i and manage a memory region of the memory expander 110 through a CXL interface 101i. According to an exemplary embodiment, the CXL interface 101i is an interface for efficiently connecting peripheral devices such as a memory expander and an accelerator, and may be based on a CXL protocol.

According to an exemplary embodiment, the processor 101 may provide a confirmation request for memory capacity information of the memory expander 110. According to an exemplary embodiment, the processor 101 may manage and control the memory region of the memory expander 110 confirmed through the confirmation request.

According to an exemplary embodiment, the processor 101 may provide an operation request for an operation supported by the memory expander 110. For example, a compression request for the data may be provided to the memory expander 110 along with the host physical address and data. In response to the compression request from the processor 101, the memory expander 110 may store compressed data generated through the compression operation. According to an exemplary embodiment, the processor 101 may utilize zSWAP, zRAM technology, etc., through the compression request for the memory expander 110.

The accelerator 103 may be a processor core or calculator that performs a specific operation. According to an exemplary embodiment, the accelerator 103 may be an operator or processor that performs a specific operation, such as a graphics processing unit (GPU) or neural processing unit (NPU), but the technical idea of the present disclosure is not limited to the examples of the accelerator types. According to an exemplary embodiment, the electronic device 100 may perform artificial intelligence (AI) calculations through the accelerator 103 and perform calculation operations under the control of the processor 101.

The accelerator 103 may include a CXL interface 103i. The accelerator 103 may receive work instructions from the processor 101 through the CXL interface 103i, and receive data from the memory expander 110 through the CXL interface 103i in response to the received work instructions. The accelerator 103 may perform an operation on the received data and store the results of the operation in the memory expander 110 through the CXL interface 103i.

The memory expander 110 is a CXL interface-based memory expander and may operate under the control of the processor 101. For example, the memory expander 110 may communicate with the processor 101 and the accelerator 103 through the CXL interface. According to an exemplary embodiment, the memory expander 110 may provide a dynamic capacity expansion function to the electronic device 100 through the CXL interface.

The processor 101 and the accelerator 103 control the memory expander 110 through the CXL interfaces 101i, 103i, and IF_CXL, so that the memory expander 110 may store data or output the stored data. According to an exemplary embodiment, the processor 101 may use at least a portion of the memory expander 110 as a memory region with a similar function to the memory 102. According to an exemplary embodiment, the memory expander 110 may correspond to a Type 3 memory device defined by the CXL standard.

The memory expander 110 may be installed or mounted on a physical port (e.g., PCIe physical port) based on the CXL interface. According to an exemplary embodiment, the memory expander 110 may be implemented based on the E1.S, E1.L, E3.S, E3.L, and PCIe AIC (CEM) form factors. According to an exemplary embodiment, the memory expander 110 may be implemented based on a U.2 form factor, an M.2 form factor, various types of PCIe-based form factors, or various other small form factors. According to an exemplary embodiment, the memory expander 110 may support a hot-plug function that can be mounted or removed from a physical port. These various functions are described, for example, in the CXL standard, CXL Specification 3.1, which is incorporated herein by reference in its entirety.

According to an exemplary embodiment, the processor 101, the accelerator 103, and the memory expander 110 may share the same interface. For example, the processor 101, the accelerator 103, and the memory expander 110 may communicate with each other through the CXL interface IF_CXL. According to an exemplary embodiment, the CXL interface IF_CXL may point to a low-latency and high-bandwidth link that support coherency, memory access, and dynamic protocol muxing of the IO protocol to enable various connections between accelerators, memory devices, or various electronic devices.

According to an exemplary embodiment, it is assumed that the components of the electronic device 100 communicate with each other through the CXL interfaces 101i, 103i, and IF_CXL, but the technical idea of the present disclosure is not limited thereto. The processor 101, the accelerator 103, and the memory expander 110 may be connected to each other based on at least one of various computing interfaces such as Gen-Z protocol, NVLink protocol, cache coherent interconnect for accelerators (CCIX) protocol, and open coherent accelerator processor interface (CAPI) protocol.

The memory expander 110 may include a controller 111 and a memory device 112. The controller 111 may store data in the memory device 112 or read data stored in the memory device 112, and may perform a compression operation on the data or a decompression operation on the compressed data. The memory device 112 may be used as a system memory or buffer memory in which the compressed data is stored.

According to an exemplary embodiment, the memory device 112 may be volatile memory such as a DDR SDRAM (Double Data Rate Synchronous DRAM), Low Power DDR (LPDDR) SDRAM, Graphics DDR (GDDR) SDRAM, RDRAM (Rambus DRAM), and HBM (High Bandwidth Memory), non-volatile memory such as Electrically Erasable Programmable Read-Only Memory (EEPROM), flash memory, Magnetic RAM (MRAM), Spin-Transfer Torque (STT)-MRAM (MRAM), Conductive Bridging RAM (CBRAM), Ferroelectric RAM (FeRAM), Phase change RAM (PRAM), Resistive RAM (RRAM), Nanotube RRAM, Polymer RAM (PoRAM), Nano Floating Gate Memory (NFGM), holographic memory, Molecular Electronic Memory Device, Non-volatile memory, such as Insulator Resistance Change Memory, a combination thereof, or dual in-line memory module (DIMM)-based memory.

According to an exemplary embodiment, the controller 111 may receive a confirmation request for memory capacity information and a compression request for data from the processor 101 through the CXL interface.

According to an exemplary embodiment, the controller 111 may support dynamic capacity changes through interaction through the CXL interface. The CXL interface 101i of the processor 101 may register Management Component Transport Protocol (MCTP)-based Component Command Interfaces (CCIs) and receive an alert or notification whenever the memory capacity of the memory device 112 of the memory expander 110, which is the target device, changes. According to an exemplary embodiment, the processor 101 may provide a device information confirmation request to the controller 111 based on the received alert or notification.

According to an exemplary embodiment, the memory expander 110 may provide the memory capacity information for a portion of the memory device 112 to the processor 101 in response to the device information confirmation request. For example, the memory expander 110 may provide the memory capacity information to the processor 101 by including the capacity a first region of the memory device 112 while excluding the capacity of a second region of the memory device 112.

According to an exemplary embodiment, the memory expander 110 may generate mapping data including mapping information of the compressed data for the data and the host physical address and the device physical address of the memory device 112 in response to the compression request for the host physical address and the data of the host physical address.

The memory expander 110 allocates a portion of the memory device 112 excluded from the memory capacity information (e.g., the second region) in the confirmation request as a dedicated reserved region for the mapping data between the host physical address and the device physical address, thereby improving a physical overhead caused by a dedicated channel for the mapping data.

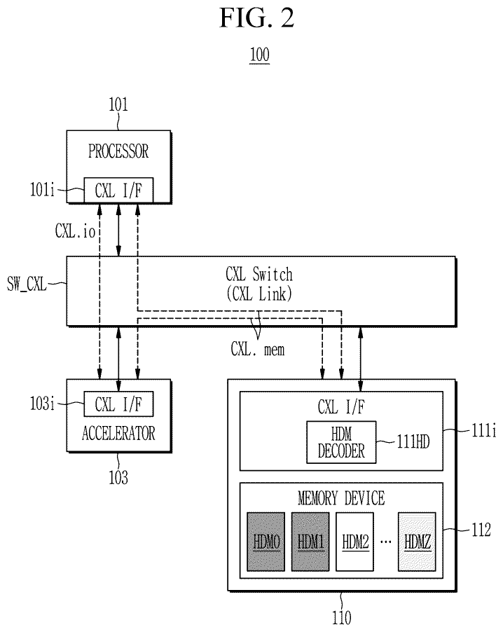

FIG. 2 is a block diagram illustrating the electronic device of FIG. 1 in detail. Referring to FIGS. 1 and 2, the electronic device 100 may include a CXL switch SW_CXL, a processor 101, an accelerator 103, and a memory expander 110.

The CXL switch SW_CXL may be a component included with the CXL interface IF_CXL. The CXL switch SW_CXL may mediate communication between the processor 101, the accelerator 103, and the memory expander 110. For example, when the processor 101 and the accelerator 103 communicate with each other, the CXL switch SW_CXL may transmit information such as request, data, response, or signal transmitted from the processor 101 or the accelerator 103 to the accelerator 103 or the processor 101. When the processor 101 and the accelerator 110 communicate with each other, the CXL switch SW_CXL may transmit information such as request, data, response, or signal transmitted from the processor 101 or the memory expander 110 to the memory expander 110 or the processor 101. When the accelerator 103 and the memory expander 110 communicate with each other, the CXL switch SW_CXL may transmit information such as request, data, response, or signal transmitted from the accelerator 103 or the memory expander 110 to the memory expander 110 or the accelerator 103.

The processor 101 may include the CXL interface 101i. The CXL interface 101i may communicate with the accelerator 103 or the memory expander 110 through the CXL switch SW_CXL.

The accelerator 103 may include the CXL interface 103i. The CXL interface 103i may be connected to the CXL switch SW_CXL. The CXL interface 103i may communicate with the processor 101 or the memory expander 110 through the CXL switch SW_CXL.

The memory expander 110 may include a host interface circuit 111i and a memory device 112 including a plurality of host-defined device memories (HDMs) HDM0 to HDMz.

According to an exemplary embodiment, the host interface circuit 111i may include an HDM decoder 111HD. The host interface circuit 111i may be connected to the CXL switch SW_CXL. The host interface circuit 111i may communicate with the processor 101 or the accelerator 103 through the CXL switch SW_CXL.

The host interface circuit 111i may be an interface circuit based on the CXL protocol. According to an exemplary embodiment, the host interface circuit 111i may support at least one of various heterogeneous computing interfaces such as Gen-Z protocol, NVLink protocol, CCIX protocol, and Open CAPI protocol other than the CXL protocol.

The HDM decoder 111HD may manage the plurality of HDMs HDM0 to HDMz. For example, the host physical address accessed from the processor 101 or the accelerator 103 may be converted into the device physical address for the plurality of HDMs HDM0 to HDMz. According to an exemplary embodiment, the processor 101 may manage the memory device 112 through the HDM decoder 111HD.

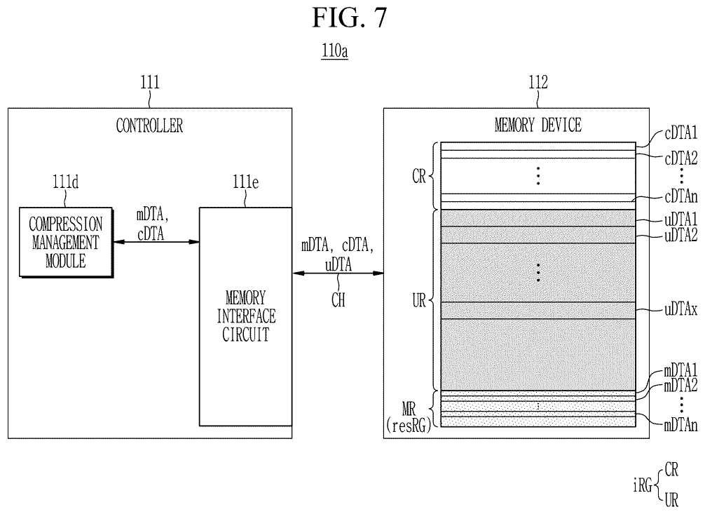

According to an exemplary embodiment, the HDM decoder 111HD may determine mapping between the host physical address and the device physical addresses for the plurality of HDMs HDM0 to HDMz during memory allocation for the memory expander 110. According to an exemplary embodiment, the HDM decoder 111HD may allocate at least some of the plurality of HDMs HDM0 to HDMz as a compressed data region CR and an uncompressed data region UR, which will be described later in FIG. 7. The allocated compressed data region CR and uncompressed data region UR may be used as accessible regions by the processor 101. According to an exemplary embodiment, the size of the uncompressed data region UR may be the same as the size of the memory 102.

According to an exemplary embodiment, the size of the plurality of HDMs HDM0 to HDMz may be 256 MB, but the technical idea of the present disclosure is not limited to the example of the size. The compressed data region CR and the uncompressed data region UR, which will be described later in FIG. 7, may be divided into the plurality of HDMs HDM0 to HDMz.

According to an exemplary embodiment, the processor 101 and the accelerator 103 may communicate with each other using CXL.io, an input/output protocol. The CXL.io may have a PCIe-based non-coherent input/output protocol. The processor 101 and the accelerator 103 may exchange user data or various information with each other using the CXL.io.

According to an exemplary embodiment, the accelerator 103 and the memory expander 110 may communicate with each other using CXL.mem, a memory access protocol. The CXL.mem may be a memory access protocol that supports accessing memory. The accelerator 103 may access some regions of the memory expander 110 using the CXL.mem

According to an exemplary embodiment, the processor 101 and the memory expander 110 may communicate with each other using CXL.mem, a memory access protocol. The processor 101 may access some regions of the memory expander 110 using the CXL.mem.

The above-described access types (CXL.io, CXL.mem, etc.) are some examples, and the scope of the present disclosure is not limited thereto.

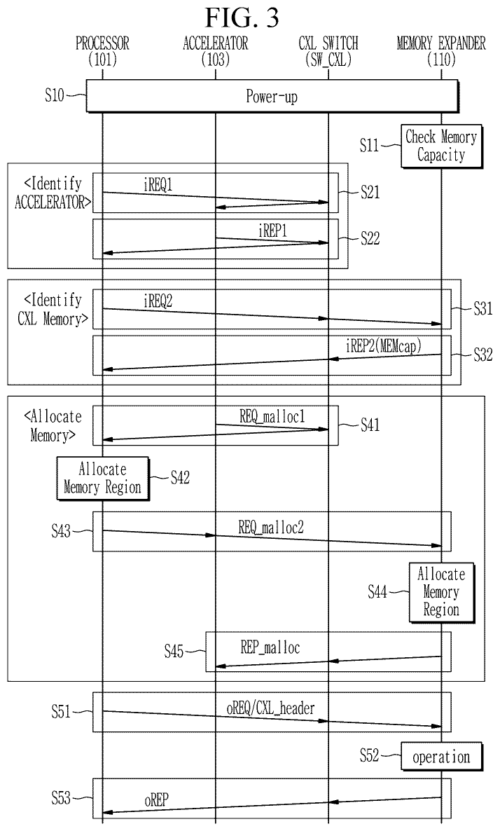

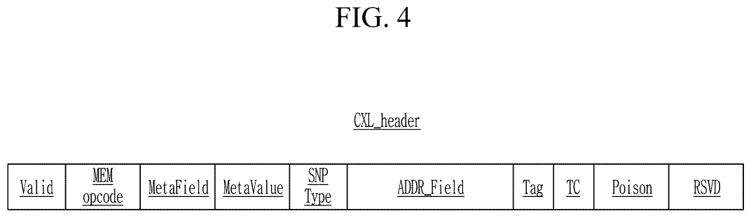

FIG. 3 is a ladder diagram illustrating an initialization operation or power-up operation of the electronic device of FIG. 2. FIG. 4 is an exemplary diagram illustrating header information of an operation request of FIG. 3.

Referring to FIGS. 2 to 4, the electronic device 100 may be powered up (S10). When the electronic device 100 is powered up, the processor 101 may transmit information about power-up or initialization start to the accelerator 103, the CXL switch SW_CXL, and the memory expander 110. In response to information about the power-up or initialization start, each of the accelerator 103, the CXL switch SW_CXL, and the memory expander 110 may perform individual initialization operations.

The memory expander 110 may confirm the memory capacity of the memory device 112. For example, the memory expander 110 may confirm the memory capacity of the memory device 112 in response to information about the power-up or initialization start of step S10.

The processor 101 may recognize the device information of the accelerator 103 (S21, S22). For example, in step S21, the processor 101 may issue a first device information confirmation request iREQ1 to recognize the device information of the accelerator 103 through the CXL interface 101i. The first device information confirmation request iREQ1 may be transmitted to the CXL switch SW_CXL. The CXL switch SW_CXL may transmit the first device information confirmation request iREQ1 to the accelerator 103, which is the target device of the first device information confirmation request iREQ1.

The memory expander 110 may output a first device information response iREP1 through the CXL interface 103i in response to the first device information confirmation request iREQ1 received from the CXL switch SW_CXL. The first device information response iREP1 may be transmitted to the CXL switch SW_CXL. The CXL switch SW_CXL may transmit the first device information response iREP1 to the processor 101 which is the target device of the first device information response iREP1.

The processor 101 may identify the device information of the accelerator 103 in response to the first device information response iREP1 received from the CXL switch SW_CXL. According to an exemplary embodiment, the first device information response iREP1 may include information about the device type and operation type of the accelerator 103.

The processor 101 may recognize or identify information about the memory expander 110 (S31, S32).

For example, in step S31, the processor 101 may issue a second device information confirmation request iREQ2 to recognize the device information of the memory expander 110 through the CXL interface 101i. The second device information confirmation request iREQ2 may be transmitted to the CXL switch SW_CXL. The CXL switch SW_CXL may transmit the second device information confirmation request iREQ2 to the memory expander 110, which is the target device of the second device information confirmation request iREQ2.

The memory expander 110 may output the second device information response iREP2 through the host interface circuit 111a in response to the second device information confirmation request iREQ2 received from the CXL switch SW_CXL. The second device information response iREP2 may be transmitted to the CXL switch SW_CXL. The CXL switch SW_CXL may transmit the second device information response iREP2 to the processor 101 which is the target device of the second device information response REP_id2. According to an exemplary embodiment, the memory expander 110 may output the memory capacity information MEMcap, which includes the capacity of a first portion of the memory device 112 and which excludes the additional capacity of a second portion of the memory device 112, as the second device information response iREP2. For example, the memory capacity information MEMcap may be a partial memory capacity of the overall memory capacity of memory device 112.

The processor 101 may identify the device information of the memory expander 110 in response to the second device information response iREP2 received from the CXL switch SW_CXL. According to an exemplary embodiment, the second device information response iREP2 may include information about the device type, the memory capacity, etc., of the memory expander 110. According to an exemplary embodiment, the processor 101 may perform a memory allocation operation based on the memory capacity information MEMcap of the second device information response iREP2.

As described above, the processor 101 may identify information about the device type, the memory capacity, etc. of the accelerator 103 and the memory expander 110 through the operations of steps S21 to S32.

The processor 101 may allocate the memory device 112 to the plurality of memory regions based on the memory capacity information MEMcap of the second device information response iREP2 (S41-S45). For example, in step S41, the accelerator 103 may output a first memory allocation request REQ_malloc1 through the CXL interface 103i. The first memory allocation request REQ_malloc1 may be transmitted to the CXL switch SW_CXL. The CXL switch SW_CXL may transmit the first memory allocation request REQ_malloc1 to the processor 101. According to an exemplary embodiment, the first memory allocation request REQ_malloc1 may be an allocation request for a region of the memory device 112 to be used as a dedicated region for the accelerator 103.

In step S42, the processor 101 may allocate a dedicated region of the accelerator 103 in response to the first memory allocation request REQ_malloc1. For example, the memory management unit within the processor 101 may manage a portion of the memory device 112 as a dedicated region of the accelerator 103 in response to the first memory allocation request REQ_malloc1.

In step S43, the processor 101 may output a second memory allocation request REQ_malloc2 through the CXL interface 101i in response to steps S41 to S42. The second memory allocation request REQ_malloc2 may be transmitted to the CXL switch SW_CXL. The CXL switch SW_CXL may transmit the second memory allocation request REQ_malloc2 to the memory expander 110. According to an exemplary embodiment, the second memory allocation request REQ_malloc2 may be a request for the processor 101 to manage the memory device 112 into a plurality of regions.

In step S44, the memory expander 110 may allocate the memory device 112 to a plurality of regions in response to the second memory allocation request REQ_malloc2. For example, the HDM decoder 111HD sets the region corresponding to the determined request information of the accelerator 103 as a dedicated region for the accelerator 103 in response to the second memory allocation request REQ_malloc2 provided from the processor 101. The HDM decoder 111HD may allocate at least a portion of the memory device 112 as the compressed data region CR and the uncompressed data region UR, which will be described later in FIG. 7.

In step S45, the memory expander 110 may output a memory allocation response REP_malloc through the host interface circuit 111i. The memory allocation response REP_malloc may be transmitted to the CXL switch SW_CXL. The CXL switch SW_CXL may transmit the memory allocation response REP_malloc to the accelerator 103, which is the target device of the memory allocation response REP_malloc. According to an exemplary embodiment, the memory allocation response REP_malloc may include information about the device identifier of the memory expander 110, the host physical address of the region allocated as a dedicated region for the accelerator 103 among the CXL memory devices 112, etc.

The accelerator 103 may identify the dedicated region for the accelerator 103 among the regions of the memory device 112 based on the memory allocation response REP_malloc.

The processor 101 may control the memory expander 110 to perform an operation through an operation request oREQ (S51 to S53). After steps S10 to S45 described above, in step S51, the processor 101 may output the operation request oREQ for the memory expander 110 along with a CXL header CXL_header through the CXL interface 101a. The operation request oREQ may be transmitted to the CXL switch SW_CXL. The CXL switch SW_CXL may transmit the operation request oREQ to the memory expander 110, which is the target device of the operation request oREQ. According to an exemplary embodiment, the operation request oREQ is for a memory operation supported by the memory expander 110 and may be one of a compression request, a read request, or a write request, which will be described later.

According to an exemplary embodiment, the operation request oREQ may be a message or communication packet requesting a memory operation, and may be provided from the processor 101 or the accelerator 103. For example, the operation request oREQ may correspond to a Master to Subordinate Request with Data (M2S RwD) message or communication packet of the CXL protocol. In this case, the operation request oREQ may include a CXL header CXL_header1, as illustrated in FIG. 4.

Referring to FIG. 4, the CXL header CXL_header may include a valid field Valid, a memory operation code field MEM opcode, a meta field MetaField, a meta value field MetaValue, a snoop type field SNP Type, an address field ADDR_Field, tag field Tag, traffic class field TC, a poison field Poison, and a reserved field RSVD.

The valid field Valid may include information about whether the corresponding request is valid.

The memory operation code field MEM opcode may include information related to memory operation. According to an exemplary embodiment, the memory operation code field MEM opcode of the operation request oREQ may include information and type (e.g., 1101, 1110, or 1111) about the memory operation in the memory expander 110. The metafield MetaField may include information indicating whether the update of metadata is required. The meta value field MetaValue may indicate the value of meta data.

The Snoop Type field SNP Type may include the information related to the Snoop Type.

The address field ADDR_Field may include information about the host physical address of the processor 101 or the accelerator 103 related to the memory operation code field MEM opcode. According to an exemplary embodiment, the address field ADDR_Field of the operation request oREQ may include first address information about the start memory address of the operation data and second address information about the end memory address of the operation data.

According to an exemplary embodiment, the HDM decoder 111HD may convert the address field ADDR_Field into the device physical addresses for the plurality of HDMs HDM0 to HDMz. According to an exemplary embodiment, the region of the memory device 112 allocated in steps S41 to S45 may be accessed based on the address field ADDR_Field.

The tag field Tag may include tag information identifying a pre-allocated memory region. According to an exemplary embodiment, the tag field of the operation request oREQ may include an operation number for the corresponding memory operation.

The traffic class field TC may include information defining the Quality of Service (QoS) associated with the request.

The poison field Poison may include information indicating whether an error is included in data related to the operation request oREQ. The reserved field RSVD may include various types of other information related to the operation request oREQ.

Although not illustrated, a position field may be additionally arranged compared to the M2S RwD fields defined by CXL standard 1.1. According to an exemplary embodiment, the position field may include an address such as metadata. The information related to the position field may be included in the reserved field RSVD or the traffic class field TC.

The field arrangement arranged in FIG. 4 is an example of the CXL header CXL_header, and the CXL header CXL_header of the operation request oREQ according to the exemplary embodiment may be generated by modifying some fields of the M2S RwD message defined by the CXL protocol.

In step S52, the memory expander 110 may perform a memory operation in response to the operation request oREQ. The memory operation may be one of a compression operation, a read operation, or a write operation, which will be described later.

In step S53, the memory expander 110 may output the operation response oREP indicating that the memory operation according to the operation request oREQ has been completed through the host interface circuit 111a. The CXL switch SW_CXL may transmit the operation response oREP to the processor 101, which is the target device of the operation response oREP. The processor 101 may recognize that the memory operation on the memory expander 110 has been completed in response to the operation response oREP.

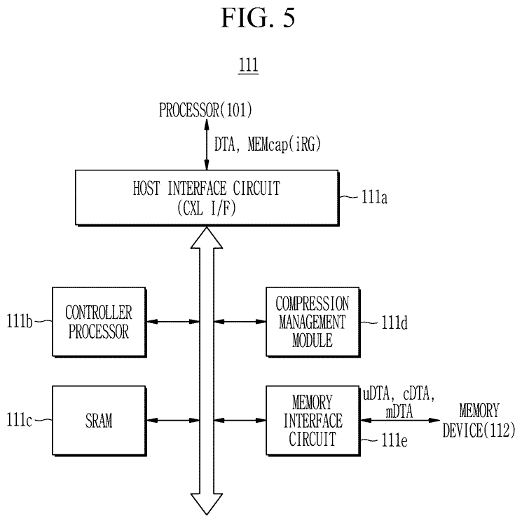

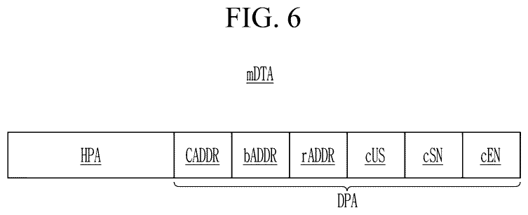

FIG. 5 is a block diagram illustrating a controller of a memory expander according to one exemplary embodiment. FIG. 6 is a diagram for describing mapping data according to an exemplary embodiment.

Referring to FIGS. 1 and 5 to 6, the controller 111 may include a host interface circuit 111a, a controller processor 111b, an SRAM 111c, a compression management module 111d, and a memory interface circuit 111e. The host interface circuit 111a may correspond to the host interface circuit 111i of FIG. 2. Each functional module (or unit) described herein may comprise a separate chip or semiconductor device, or some or all of the functional module (or unit) may be comprised of and share a single chip or semiconductor device. Connections and interactions between the units described herein may be hardwired and/or in the form of data (e.g., as data stored in and retrieved from memory of the computer, such as a register, buffer, cache, storage drive, etc., such as part of an application programming interface (API)). The functional modules (or units) of controller 111 (e.g., 111a-111e) may each correspond to a separate segment or segments of hardware and/or software and/or may correspond to segment(s) of hardware and/or software that also correspond to one or more other functional modules (or units) described herein (e.g., the functional modules (or units) may share certain segment(s) of hardware or software or be embodied by the same segment(s) of hardware and/or software). As is understood, “software” refers to prescribed rules to operate a computer, such as code or script.

The controller 111 may communicate with the processor 101 and the accelerator 103 through the host interface circuit 111a. According to an exemplary embodiment, the controller 111 may transmit and receive data DTA through the host interface circuit 111a. According to an exemplary embodiment, the controller 111 may transmit and receive memory capacity information MEMcap for the confirmation region iRG in response to a confirmation request through the host interface circuit 111a. The confirmation request may correspond to the second device information response iREP2 of FIG. 3, and the memory capacity information MEMcap may correspond to the memory capacity information MEMcap in step S32 of FIG. 3.

According to an exemplary embodiment, the size of data DTA may be 4 KB, which may be a page, which is a unit processed by the processor 101. The confirmation region iRG will be described later in the description of FIG. 7.

The controller processor 111b may control the overall operation of the controller 111 or the memory expander 110. The SRAM 111c may operate as a buffer memory or system memory of the controller 111. Components such as the compression management module 111d described below (or other modules or units described herein) may be implemented in software, hardware, or a combination thereof. Components implemented as software may be stored in the SRAM 111c and driven by the controller processor 111b.

According to an exemplary embodiment, the controller processor 111b may provide commands and addresses to the memory device 112. The memory device 112 may perform a read operation or a write operation based on the command and address provided from the controller processor 111b.

According to an exemplary embodiment, the controller processor 111b may provide a read command for compressed data cDTA to the memory device 112 based on the mapping data mDTA loaded into the SRAM 111c.

The compression management module 111d may perform a compression operation on data DTA and generate compressed data cDTA in response to a compression request from the processor 101. According to an exemplary embodiment, the compression management module 111d may perform a compression operation by a compression algorithm including the Iz0, Iz4, Iz4hc, 842 algorithm, etc., but the technical ideas of the present disclosure are not limited to the algorithm example. According to an exemplary embodiment, the size of the compressed data cDTA may be 1 KB, 2 KB, or 3 KB, but is not limited thereto.

The compression management module 111d may perform a compression operation and a mapping operation for the host physical address HPA provided with the compression request. The compression management module 111d may perform a mapping operation to generate mapping data mDTA including mapping information between the host physical address HPA and the device physical address DPA of the memory device 112.

Referring to FIG. 6, the mapping data mDTA may include the host physical address HPA and the device physical address DPA that correspond to each other.

In the compression operation, the actual storage location of the host physical address HPA and compressed data cDTA used by the processor 101, which is the host device, in the memory device 112 may not match. According to an exemplary embodiment, the host physical address HPA for the compressed data cDTA may be address information virtually secured by the operating system or driver running on the electronic device 100.

The mapping data mDTA according to an exemplary embodiment may include mapping information between a host physical address HPA used as a physical address of compressed data cDTA in the processor 101, and a device physical address (DPA) in which the compressed data cDTA is stored in the memory device 112. According to an exemplary embodiment, the controller 111 may access compressed data cDTA through the mapping data mDTA.

According to an exemplary embodiment, the device physical address DPA may include a channel address CADDR where the compressed data cDTA is stored, a bank address bADDR, a row address rADDR, a compression unit size cUS, a column start number cSN, and a column end number cEN. The device physical address DPA may contain a physical location where the compressed data cDTA is stored in the memory device 112. According to an exemplary embodiment, the device physical address DPA may include address information of the compressed data region CR of FIG. 7.

The channel address CADDR, the bank address bADDR, and the row address rADDR may be address information for distinguishing the physical memory region of the memory device 112 where the compressed data cDTA is stored. Each channel address CADDR, bank address bADDR, and row address rADDR may include channel information, bank information, and row information in the memory device 112.

According to an exemplary embodiment, the compression unit size cUS may include the unit size of the compressed data cDTA and may be determined by the compression operation of the compression management module 111d. According to an exemplary embodiment, the compression unit size cUS may include information indicating 1 KB, 2 KB, or 3 KB, but is not limited thereto.

The column start number cSN and column end number cEN may include the column address information in which the compressed data cDTA is stored in the row address rADDR. The column start number cSN represents the column start address in which the compressed data cDTA is stored in the memory region indicated by the row address rADDR, and the column end number cEN may indicate the column end address in which the compressed data cDTA is stored in the memory region indicated by the row address rADDR. According to an exemplary embodiment, the size of the mapping data mDTA may be 8 bytes, 16 bytes, 32 bytes, or 64 bytes.

Referring back to FIG. 5, each of the compressed data cDTA and mapping data mDTA may be provided to the memory device 112 along with the write command to store the compressed data cDTA in the compressed data region CR (FIG. 7) of the memory device 112, and each mapping data mDTA may be written in the mapping data region MR (FIG. 7).

The compression management module 111d may manage the entry of the mapping data mDTA and may include a hash table for managing the entry of the mapping data mDTA. According to an exemplary embodiment, the hash table may include index information about the host physical address. According to an exemplary embodiment, the compression management module 111d may provide a read command for the mapping data mDTA in response to the read request from the processor 101. The mapping data mDTA read from the memory device 112 may be loaded into the SRAM 111c.

The compression management module 111d may generate data DTA by performing the decompression operation on the compressed data cDTA in response to the request from the processor 101. According to an exemplary embodiment, the compression management module 111d may perform the decompression operation on the compressed data cDTA read from the memory device 112 in response to the read request from the processor 101.

The controller 111 may control the memory device 112 through the memory interface circuit 111e. The memory interface circuit 111e may support various interfaces depending on the type of memory device 112. According to an exemplary embodiment, the memory interface circuit 111e may support a memory interface such as a DDR interface, a toggle interface, etc.

The controller 111 provides the compressed data cDTA, the mapping data mDTA, and the uncompressed data uDTA on which no compression operation has been performed on the data DTA to the memory device 112 through the memory interface circuit 111e. According to an exemplary embodiment, the processor 101 may access some regions of the memory device 112 through the CXL interface 101i and the memory interface circuit 111e.

FIG. 7 is a diagram for describing a memory expander according to an exemplary embodiment. Specifically, the memory expander 110a of FIG. 7 may be an example of the memory expander 110 of FIGS. 1 to 6.

FIGS. 1 to 7, the controller 111 and the memory device 112 may be connected through a channel CH, and the commands, addresses, compressed data cDTA, mapping data mDTA, and uncompressed data uDTA may be transmitted and received through the channel CH. According to an exemplary embodiment, the memory interface circuit 111e of the controller 111 may include a data pin and an address pin corresponding to the channel CH.

FIG. 7 illustrates that one memory device 112 is connected to a channel CH, but the technical idea of the present disclosure is not limited thereto, and a plurality of memory devices may be connected to one channel CH according to some embodiments.

The memory device 112 may include the compressed data region CR, the uncompressed data region UR, and the mapping data region MR. The compressed data region CR is a region where the compressed data cDTA is stored, and the first to nth compressed data cDTA1 to cDTAn, which are the compressed data cDTA, may be stored in the compressed data region CR. The allocation to the compressed data region CR in the memory device 112 may be performed as in steps S41 to S45 of FIG. 3. According to an exemplary embodiment, the HDM decoder 111HD may determine the mapping between the host physical address HPA and the compressed data region CR.

The size of each of the first to nth compressed data cDTA1 to cDTAn may be 1 KB, 2 KB, or 3 KB, but is not limited to the above example and may be determined by the compression algorithm of the compression operation of the compression management module 111d.

According to an exemplary embodiment, the plurality of compressed data cDTA among the first to nth compressed data cDTA1 to cDTAn (e.g., a plurality of pieces of data) may be stored in the memory region corresponding to one row address in the compressed data region CR. According to an exemplary embodiment, the first to nth compressed data cDTA1 to cDTAn in the compressed data region CR may be managed by the compression management module 111d, and the compression management module 111d may perform allocation and de-allocation operations for the compressed data region CR in the memory device 112.

The uncompressed data region UR is a region where uncompressed data uDTA is stored, and the first to xth uncompressed data uDTA1 to uDTAx, which are uncompressed data uDTA, may be stored in the uncompressed data region UR. The allocation to the uncompressed data region UR in the memory device 112 may be performed as in steps S41 to S45 of FIG. 3. According to an exemplary embodiment, the HDM decoder 111HD may determine the mapping between the host physical address HPA and the uncompressed data region UR.

The size of each of the first to xth uncompressed data uDTA1 to uDTAx may be 4 KB, but is not limited to this example and may be determined by the size of the page or segment processed by processor 101.

According to an exemplary embodiment, a plurality of uncompressed data uDTA among the first to xth uncompressed data uDTA1 to uDTAx may be stored in the memory region corresponding to one row address in the uncompressed data region UR. For example, when the memory region corresponding to one row address stores data of 8 KB in size, two uncompressed data uDTA (e.g., two separate pieces of data) corresponding to two pages may be stored in the memory region corresponding to one row address. According to an exemplary embodiment, the uncompressed data region UR in the memory device 112 may be managed as the system memory by the processor 101 through the CXL interface 101i and the memory interface circuit 111e.

The mapping data region MR is a region where mapping data mDTA is stored, and the first to nth mapping data mDTA1-mDTAn may be stored in the mapping data region MR. According to an exemplary embodiment, the mapping data mDTA may include the mapping information about the host physical address for the compressed data cDTA and the device physical address where the compressed data cDTA is stored in the memory device 112. Each of the first to nth mapped data mDTA1 to mDTAn may include the mapping information for each of the first to nth compressed data cDTA1 to cDTAn. Each of the first to nth mapping data mDTA1 to mDTAn may be 8 bytes, 16 bytes, 32 bytes, or 64 bytes, but is not limited to the above example and may be determined by the mapping operation of the compression operation of the compression management module 111d.

According to an exemplary embodiment, the plurality of mapping data mDTA among the first to nth mapping data mDTA1 to mDTAn may be stored in the memory region corresponding to one row address in the mapping data region MR. According to an exemplary embodiment, the first to nth mapping data mDTA1 to mDTAn in the mapping data region MR may be managed by the compression management module 111d, and the compression management module 111d may perform allocation and de-allocation operations for the mapping data region MR in the memory device 112.

According to exemplary embodiments, the compressed data region CR and the uncompressed data region UR are the confirmation region iRG, and may be the memory region corresponding to the memory capacity information (MEMcap) reported to the processor 101 in response to the confirmation request for memory capacity information of processor 101. According to an exemplary embodiment, the confirmation region iRG may be confirmed by the processor 101 through the provided memory capacity information MEMcap and managed as the system memory by the processor 101. According to an exemplary embodiment, in steps S41 to S45 of FIG. 3, the compressed data region CR and the uncompressed data region UR may be allocated within the confirmation region iRG.

According to an exemplary embodiment, the mapping data region MR is a reserved region resRG and may be the memory region that is missed from the report of the processor 101 in response to the confirmation request for the memory capacity information of the processor 101. According to an exemplary embodiment, the reserved region resRG is a memory region where the mapping data mDTA is exclusively stored and may be managed by the controller 111. According to an exemplary embodiment, the size of the reserved region resRG may be a size that is a multiple of 256 MB, 512 MB, or 1024 MB, but is not limited thereto and may vary depending on the memory configuration of the system memory for the processor 101.

Through the mapping data region MR of the memory device 112, the memory expander 110a may reduce or eliminate the need for a separate memory device storing the mapping data mDTA and a separate channel for the memory device, and the controller 111 may improve a physical overhead such as data pin and address pin arrangement required for the channel.

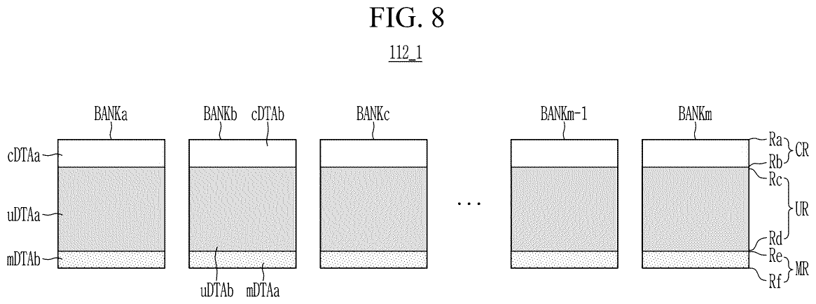

FIG. 8 is a diagram describing a plurality of banks in a memory device according to an exemplary embodiment. Specifically, FIG. 8 is a diagram illustrating an example of memory region allocation in a plurality of banks. The memory device 112_1 of FIG. 8 corresponds to the memory device 112 of FIGS. 1 to 7 and may be an example of the memory device 112 of FIGS. 1 to 7. The description of the memory device 112 of FIGS. 1 to 7 applies to the memory device 112_1 of FIG. 8.

Referring to FIGS. 1 to 8, the memory device 112_1 may be divided into a plurality of memory regions in bank units and may include a plurality of banks BANKa to BANKm that are continuously operated during data input and output. The memory device 112_1 may perform a bank interleaving operation through a plurality of banks BANKa to BANKm.

Each of the plurality of banks BANKa to BANKm may include a plurality of rows Ra to Rf, and may store data in row units. During the bank interleaving operation according to an exemplary embodiment, data corresponding to a plurality of rows arranged in different banks may be read or written together through a single access. According to an exemplary embodiment, the row address of each bank processed by the same access during the bank interleaving operation may be the same or different. As an example, when an a-th row Ra of an a-th bank BANKa is accessed, a b-th row Rb of a b-th bank BANKb may be accessed.

Each of the plurality of banks BANKa to BANKm may include the compressed data region CR, the uncompressed data region UR, and the mapping data region MR. In one bank, the compressed data region CR, the uncompressed data region UR, and the mapping data region MR may each be divided into row units.

Each of the plurality of banks BANKa to BANKm may include the mapping data region MR, which is a reserved region resRG. For example, referring to FIG. 8, predetermined eth to fth rows Re and Rf among the plurality of rows Ra to Rf in the plurality of banks BANKa to BANKm may be the mapping data region MR. Among the plurality of rows Ra to Rf, the ath to bth rows Ra and Rb may be the compressed data region CR, and the cth to dth rows Rc and Rd among the plurality of rows Ra to Rf may be an uncompressed data region UR, but the embodiments are not limited thereto.

In FIG. 8, the mapping data regions MR of all banks BANKa to BANKm of the memory device 112_1 are illustrated as eth to fth rows Re to Rf, but are not limited thereto, and the rows corresponding to the mapping data regions may be variously changed according to the bank.

In the memory device 112_1, the mapping data mDTA within a specific bank may include the mapping information of the compressed data cDTA of another bank. For example, referring to FIG. 8, the bth mapping data mDTAb stored in the mapping data region MR of the ath bank BANKa may include the mapping information for the bth compressed data cDTAb stored in the compressed data region CR of the bth bank BANKb. The ath mapping data mDTAa stored in the mapping data region MR of the bth bank BANKb may include the mapping information for the ath compressed data cDTAa stored in the compressed data region CR of the ath bank BANKb.

Through the memory region allocation and bank interleaving operations described above, the memory device 112_1 may reduce the number of times of accesses for a read or write operation of the compressed data cDTA and efficiently perform a read or write operation of the compressed data cDTA.

While the mapping data mDTA for the compressed data cDTA stored in one bank is stored in a specific bank, the mapping data mDTA for adjacently and sequentially written compressed data cDTA may be written and read adjacently and sequentially in a specific bank based on locality.

In the drawing, the memory device 112_1 is illustrated as including a plurality of banks BANKa to BANKm, but when the memory device 112_1 is a memory module, that plurality of banks BANKa to BANKm may be replaced with a plurality of ranks (Rank).

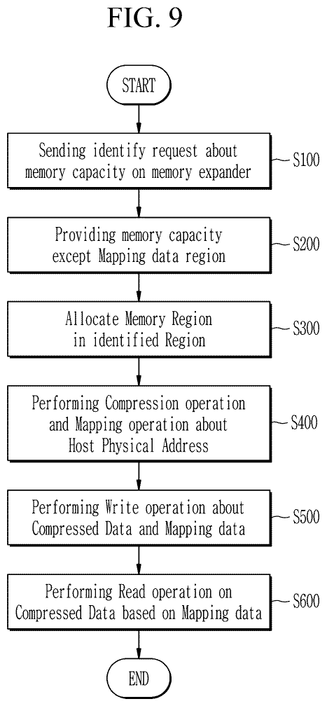

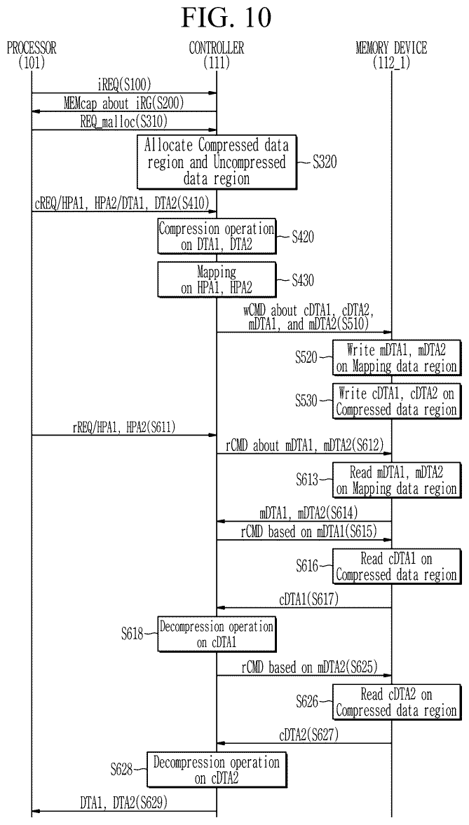

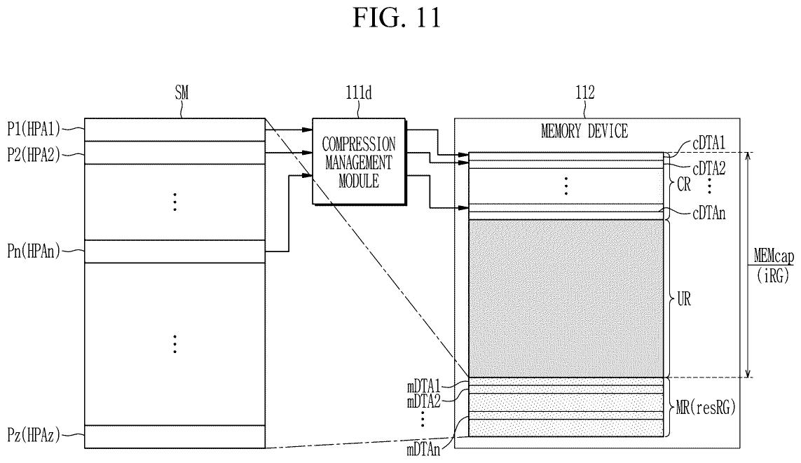

FIG. 9 is a flowchart illustrating a method of operating an electronic device according to an exemplary embodiment. FIG. 10 is a ladder diagram illustrating a method of operating an electronic device according to an exemplary embodiment. FIG. 11 is a diagram for describing a method of operating an electronic device according to an exemplary embodiment. Specifically, FIG. 10 is a diagram for describing a write operation and a read operation of the compressed data cDTA in the memory device 112_1 of FIG. 8.

Referring to FIGS. 1 to 10, the processor 101 provides a confirmation request iREQ for the memory capacity information MEMcap to the memory expander 110 (S100).

According to an exemplary embodiment, as the electronic device 100 boots up, the processor 101 may provide the confirmation request iREQ for memory capacity information MEMcap to the memory expander 110.

According to an exemplary embodiment, as the memory region allocation in the system memory (SM) changes, the processor 101 may provide a confirmation request iREQ for memory capacity information MEMcap to the memory expander 110. The confirmation request iREQ may correspond to the second device information confirmation request iREQ2 in FIG. 3.

The system memory SM is memory managed by the processor 101, which is a host device, and may include the memory 102 and at least a portion of the memory device 112_1. According to an exemplary embodiment, the system memory SM may be managed with page frames P1 to Pz corresponding to pages, but is not limited thereto. According to an exemplary embodiment, the size of the page may be 4 KB or 8 KB, but is not limited thereto, and the size of the page frame may be the same as the size of the page. Each of the plurality of page frames P1 to Pz may correspond to each of the plurality of host physical addresses HPA1 to HPAz.

The memory expander 110 provides the memory capacity information MEMcap for the confirmation region iRG to the processor 101 in response to the confirmation request iREQ (S200).

The memory expander 110 may provide the processor 101 with the memory capacity information MEMcap for the confirmation region iRG excluding the reserved region resRG in the memory device 112_1. The memory capacity information MEMcap may correspond to the memory capacity information MEMcap in step S32 of FIG. 3.

According to an exemplary embodiment, the size of the confirmation region iRG and the reserved region resRG may be in units of 256 MB. According to an exemplary embodiment, the size of the reserved region resRG may be 256 MB or 512 MB, but is not limited thereto. According to an exemplary embodiment, the size of the reserved region resRG may be determined by the number of page frames P1 to Pz and the size of the mapping data mDTA.

The confirmation region iRG for the memory capacity information MEMcap provided to the processor 101 may be managed by the processor 101 as the system memory SM.

The processor 101 allocates the memory region within the confirmation region IRG (S300). The processor 101 may provide the memory allocation request REQ_malloc for the compressed data region CR and the uncompressed data region UR (S310).

The controller 111 may allocate a compressed data region CR and an uncompressed data region UR within the confirmation region iRG (S320). In the memory allocation process for the memory expander 110, the HDM decoder 111HD may allocate at least a portion of the confirmation region iRG to the compressed data region CR and at least a portion of the confirmation region iRG to the uncompressed data region UR. According to an exemplary embodiment, the size of the uncompressed data region UR may be the same as the size of the memory 102.

The memory expander 110 performs the data DTA compression and mapping operations on the host physical address HPA (S400).

For example, referring to FIG. 10, the processor 101 provides the controller 111 with the compression request cREQ along with the first and second host physical addresses HPA1 and HPA2 and first and second data DTA1 and DTA2 for the first and second host physical addresses HPA1 and HPA2. According to an exemplary embodiment, the compression request cREQ may be one of the operation requests oREQ of FIG. 3, and the compression operation to be described later may be one of the memory operations supported by the memory expander 110.

The compression management module 111d may generate first and second compressed data cDTA1 and cDTA2 by performing the compression operation on the first and second data DTA1 and DTA2 (S420).

The compression management module 111d may generate first and second mapping data mDTA1 and mDTA2 by performing a mapping operation on the first and second host physical addresses HPA1 and HPA2 (S430). Although step S420 is illustrated in FIG. 10 as preceding step S430, it is not limited thereto and may be performed together or step S430 may precede step S420, according to the exemplary embodiments.

The memory device 112_1 performs a write operation on the compressed data CDTA and the mapping data mDTA (S500)

The controller 111 may provide a write command wCMD for the first and second compressed data cDTA1 and cDTA2 and the first and second mapping data mDTA1 and mDTA2 generated in the memory device 112_1 (S510).

The memory device 112_1 may write the first and second mapping data mDTA1 and mDTA2 for the first and second compressed data cDTA1 and cDTA2 to the mapping data region MR (S520). According to an exemplary embodiment, the first and second mapping data mDTA1 and mDTA2 may be written to the same bank. According to an exemplary embodiment, the first and second mapping data mDTA1 and mDTA2 may be sequentially written to the same row of the same bank based on the locality.

The memory device 112_1 may write the first and second compressed data CDTA1 and cDTA2 to the compressed data region CR (S530). According to an exemplary embodiment, the first and second compressed data cDTA1 and cDTA2 may be sequentially written to the same bank. In FIG. 10, step S520 is shown as preceding step S530, but it is not limited thereto and may be performed together or step S530 may precede step S520, according to the exemplary embodiment.

Through operation S500, a plurality of mapping data mDTA1 to mDTAn including the first and second mapping data mDTA1 and mDTA2 may be stored in the mapping data region MR, which is the reserved region resRG, and the plurality of mapping data cDTA1 to cDTAn including the first and second compressed data cDTA1 and cDTA2 may be stored in the compressed data region CR.

The memory expander 110 performs a read operation on the compressed data CDTA based on the mapping data mDTA (S600).

The processor 101 may provide a read request rREQ for the first and second host physical addresses HPA1 and HPA2 to the controller 111 (S611). According to an exemplary embodiment, the read request rREQ may be one of the operation requests oREQ of FIG. 3, and the read operation according to the read request, which will be described later, may be one of the memory operations supported by the memory expander 110.

The controller 111 may provide a read command rCMD for the first and second mapping data mDTA1 and mDTA2 to the memory device 112_1 (S612). The controller 111 may provide the read command rCMD for the first and second mapping data mDTA1 and mDTA2 to the memory device 112_1 based on index information corresponding to the first and second host physical addresses HPA1 and HPA2.

The memory device 112_1 may perform the read operation on the first and second mapping data mDTA1 and mDTA2 in response to the read command rCMD of step S612 (S613).

According to an exemplary embodiment, the first and second mapping data mDTA1 and mDTA2 may be stored in the same row of the same bank based on the locality. The first and second mapping data mDTA1 and mDTA2 may be read together in response to the read command rCMD.

The memory device 112_1 may provide the read first and second mapping data mDTA1 and mDTA2 to the controller 111 (S614).

The first and second mapping data mDTA1 and mDTA2 provided to the controller 111 may be loaded into the SRAM 111c. According to an exemplary embodiment, the first and second mapping data mDTA1 and mDTA2 may be provided to the controller 111 in the form of the mapping table.

The controller 111 may provide the read command rCMD for the first compressed data cDTA1 to the memory device 112_1 based on the first mapping data mDTA1 (S615). The controller 111 may provide the read command rCMD to the memory device 112_1 along with the device physical address included in the first mapping data mDTA1.

The memory device 112_1 may perform the read operation on the first compressed data cDTA1 in response to the read command rCMD in step S615 (S616). The memory device 112_1 may perform the read operation for the first compressed data CDTA1 on the first mapping data mDTA1 based on the device physical address.

The memory device 112_1 may provide the read first compressed data cDTA1 to the controller 111 (S617).

The controller 111 may generate first data DTA1 by performing the decompression operation on the read first compressed data cDTA1 (S618).

The controller 111 may provide the read command rCMD for the second compressed data cDTA2 to the memory device 112_1 based on the second mapping data mDTA2 (S625). The controller 111 may provide the read command rCMD to the memory device 112_1 along with the device physical address included in the second mapping data mDTA2.

The memory device 112_1 may perform the read operation on the second compressed data cDTA2 in response to the read command rCMD of step S625 (S626). The memory device 112_1 may perform the read operation on the second compressed data cDTA2 based on the device physical address of the second mapping data mDTA2.

The memory device 112_1 may provide the read second compressed data cDTA2 to the controller 111 (S627).

The controller 111 may generate second data DTA2 by performing the decompression operation on the read second compressed data cDTA2 (S628).

The controller 111 may provide the first and second data DTA1 and DTA2 to the processor 101 in response to a read request rREQ for the first and second host physical addresses HPA1 and HPA2 (S629). Providing the first and second data DTA1 and DTA2 may correspond to the operation response oREP in step S53 of FIG. 3.

In the drawing, steps S615 to S618 are illustrated as preceding steps S625 to S628, but this is not limited as such, and according to the exemplary embodiments, steps S625 to S628 may be operated preceding steps S615 to S618.

The memory device 112_1 may allocate a predetermined row to each bank as a reserved region and store a plurality of mapping data in the reserved region based on the locality of the mapping data. The memory device 112_1 may prefetch and load adjacent mapping data and efficiently perform the read or write operation of the compressed data CDTA.

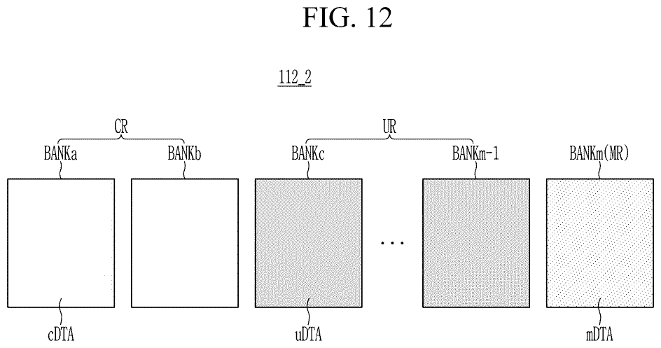

FIG. 12 is a diagram describing a plurality of banks in a memory device according to an exemplary embodiment. Specifically, FIG. 12 is a diagram illustrating an example of memory region allocation in a plurality of banks. The memory device 112_2 of FIG. 12 corresponds to the memory device 112 of FIGS. 1 to 7 and may be an example of the memory device 112 of FIGS. 1 to 7. The description of the memory device 112 of FIGS. 1 to 7 applies to the memory device 112_2 of FIG. 12.

Referring to FIGS. 1 to 7 and 12, the memory region in the memory device 112_2 may be divided into banks, and the memory device 112_2 has a plurality of banks BANKa to BANKm that are continuously operated during data input and output. The memory device 112_2 may perform a bank interleaving operation through the plurality of banks BANKa to BANKm.

The compressed data region CR may include ath to bth banks BANKa to BANKb. The uncompressed data region UR may include cth to n−1th banks BANK to BANKn−1. The mapping data region MR, which is the reserved region resRG, may include the mth bank BANKm. The memory device 112_2 may exclusively store the mapping data mDTA in one bank.

In the memory device 112_2, the mth bank BANKm, which is the mapping data region MR, may include the mapping information about the compressed data cDTA of the ath to bth banks BANKa to BANKb, which are the compressed data regions CR.

The arrangement of the compressed data region CR, the uncompressed data region UR, and the mapping data region MR according to the bank in FIG. 12 is an example, and is not limited thereto. According to an exemplary embodiment, the arrangement of the compressed data region CR, the uncompressed data region UR, and the mapping data region MR may be variously changed.

Through the memory region allocation and the bank interleaving operations described above, the memory device 112_2 may simultaneously access the compressed data cDTA, the uncompressed data uDTA, and the mapping data mDTA. For example, the memory device 112_2 may efficiently perform the access operation for the read or write operation in random writing or random reading for the plurality of compressed data CDTA through the above simultaneous access.

In the drawings, the memory device 112_2 is illustrated as including the plurality of banks BANKa to BANKm, but when the memory device 112_2 is a memory module, the plurality of banks BANKa to BANKm may instead be a plurality of ranks.

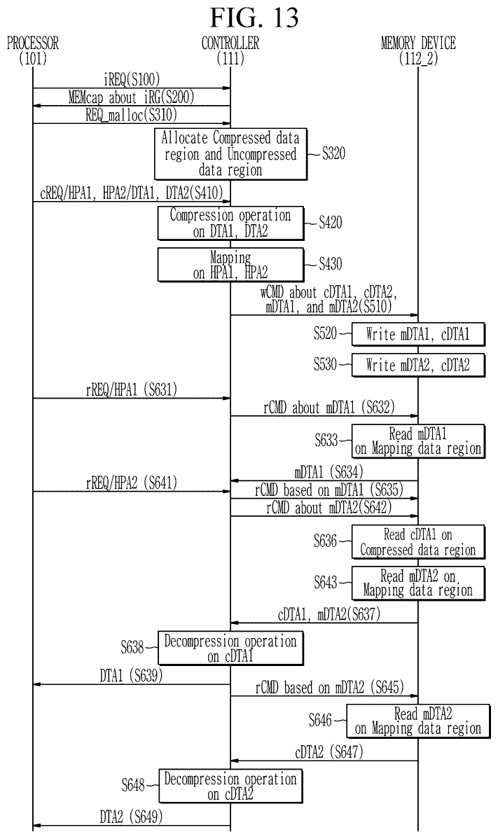

FIG. 13 is a ladder diagram illustrating a method of operating an electronic device according to an exemplary embodiment. Specifically, FIG. 13 is a diagram for describing the write operation and the read operation of compressed data cDTA in the memory device 112_2 of FIG. 12.

Steps S100 to S530 of FIG. 13 may correspond to steps S100 to S530 of FIG. 10, and the description of steps S100 to S530 of FIG. 13 focuses on the differences from steps S100 to S530 of FIG. 10. The common description may be replaced with the description of steps S100 to S530 of FIG. 10.

Referring to FIGS. 1 to 7, 9, 12, and 13, the memory device 112_2 may write first mapping data mDTA1 for the first compressed data cDTA1 to the mapping data region MR and write the first compressed data cDTA1 to the compressed data region CR (S520). According to an exemplary embodiment, the first mapping data mDTA1 and the first compressed data cDTA1 may be written to different banks.

The memory device 112_2 may write the second mapping data mDTA2 for the second compressed data cDTA2 to the mapping data region MR and write the second compressed data cDTA2 to the compressed data region CR (S530). According to an exemplary embodiment, the second mapping data mDTA2 and the second compressed data cDTA2 may be written to different banks.

According to an exemplary embodiment, the first compressed data cDTA1 and the second compressed data cDTA2 may be written to the same or different banks depending on the operation of the memory device 112_2. Although step S520 is illustrated in FIG. 13 as preceding step S530, step S530 may precede step S520.

The memory expander 110 performs a read operation on the compressed data cDTA based on the mapping data mDTA (S600).

The processor 101 may provide the read request rREQ for the first host physical address HPA1 to the controller 111 (S631). According to an exemplary embodiment, the read request rREQ may be one of the operation requests oREQ of FIG. 3, and the read operation according to the read request, which will be described later, may be one of the memory operations supported by the memory expander 110.

The controller 111 may provide the read command rCMD for the first mapping data mDTA1 to the memory device 112_2 (S632). The controller 111 may provide the read command rCMD for the first mapping data mDTA1 to the memory device 112_2 based on the index information corresponding to the first host physical address HPA1.

The memory device 112_2 may perform the read operation on the first mapping data mDTA1 in response to the read command rCMD of step S632 (S633).

The memory device 112_2 may provide the read first mapping data (mDTA1) to the controller 111 (S634). The first mapping data mDTA1 provided to the controller 111 may be loaded into the SRAM 111c.

The processor 101 may provide the read request rREQ for the second host physical address HPA2 to the controller 111 (S641). In the drawing, steps S632 to S634 are illustrated as preceding step S641, but this is not limited, and step S641 may be performed while performing steps S632 to S634, according to an exemplary embodiment.

The controller 111 may provide the read command rCMD for the first compressed data cDTA1 to the memory device 112_2 based on the first mapping data mDTA1 (S635). The controller 111 may provide the read command rCMD to the memory device 112_2 along with the device physical address included in the first mapping data mDTA1.

The controller 111 may provide the read command rCMD for the second mapping data mDTA2 to the memory device 112_2 (S642). The controller 111 may provide the read command rCMD for the second mapping data mDTA2 to the memory device 112_2 based on the index information corresponding to the second host physical address HPA2. In the drawing, step S635 is illustrated as preceding step S642, but is not limited thereto and may be performed together or step S642 may precede step S635, according to the exemplary embodiment.

The memory device 112_2 may perform the read operation on the first compressed data cDTA1 in response to the read command rCMD of step S635 (S636). The memory device 112_2 may perform the read operation for the second compressed data cDTA2 on the first mapping data mDTA1 based on the device physical address.

The memory device 112_2 may perform the read operation on the second mapping data mDTA2 in response to the read command rCMD of step S642 (S643). In the drawing, step S635 is illustrated as preceding step S642, but is not limited thereto and may be performed together according to the exemplary embodiment or step S643 may precede step S636.

The memory device 112_2 may provide the read first compressed data cDTA1 and second mapped data mDTA2 to the controller 111 (S637). According to an exemplary embodiment, the memory device 112_2 may provide the read first compressed data cDTA1 and the second mapped data mDTA2 to the controller 111 using an interleaving manner.

The second mapping data mDTA2 provided to the controller 111 may be loaded into the SRAM 111c.

The controller 111 may generate first data DTA1 by performing the decompression operation on the read first compressed data cDTA1 (S638).

The controller 111 may provide the first data DTA1 to the processor 101 in response to the read request rREQ for the first host physical address HPA1 (S639). Providing the first data DTA1 may correspond to the operation response oREP in step S53 of FIG. 3.

The controller 111 may provide the read command rCMD for the second compressed data cDTA2 to the memory device 112_2 based on the second mapping data mDTA2 (S645). The controller 111 may provide the read command rCMD to the memory device 112_2 along with the device physical address included in the second mapping data mDTA2. In the drawing, step S637 and step S638 are illustrated as preceding step S645, but are not limited thereto and may be performed together according to the exemplary embodiment, or step S645 may precede step S637 and step S638.

The memory device 112_2 may perform the read operation on the second compressed data cDTA2 in response to the read command rCMD of step S645 (S646). The memory device 112_2 may perform the read operation on the second compressed data cDTA2 based on the device physical address of the second mapping data mDTA2.

The memory device 112_1 may provide the read second compressed data cDTA2 to the controller 111 (S647).

The controller 111 may generate second data DTA2 by performing the decompression operation on the read second compressed data cDTA2 (S648).

The controller 111 may provide the second data DTA2 to the processor 101 in response to the read request rREQ for the second host physical address HPA2 (S649). Providing the second data DTA2 may correspond to the operation response oREP in step S53 of FIG. 3.

The memory device 112_2 may allocate a specific bank as a reserved region to store the mapping data and efficiently perform the read or write operation through simultaneous access to the compressed data and mapping data. For example, the memory device 112_2 may efficiently perform the access operation for the read or write operation through simultaneous access to the compressed data and mapping data in random write or random read.

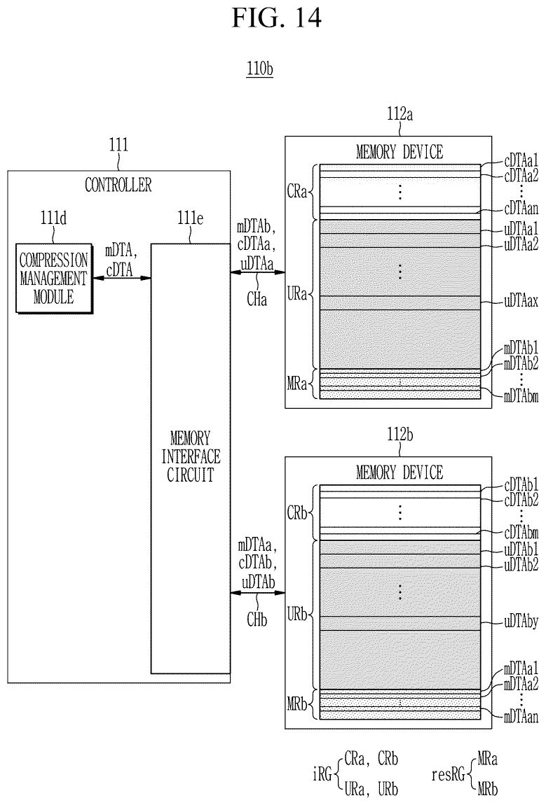

FIG. 14 is a diagram for describing a memory expander according to an exemplary embodiment. Specifically, the memory expander 110b of FIG. 14 may be an example of the memory expander 110 of FIGS. 1 to 5.

Referring to FIGS. 1 to 5 and FIG. 14, the memory device 112 of the memory expander 110b may include an ath memory device 112a and a bth memory device 112b that are different from each other. The controller 111 and the ath memory device 112a may be connected through an ath channel CHa. The controller 111 and the bth memory device 112b may be connected through a bth channel CHb that is different from the ath channel CHa.

The compression management module 111d of the controller 111 may perform the compression operation to generate the compressed data cDTA and the mapping data mDTA for the compressed data cDTA. The compressed data cDTA may include the ath compressed data cDTAa and the bth compressed data cDTAb. The mapping data mDTA may include the ath mapping data mDTAa for the ath compressed data cDTAa and the bth mapping data mDTAb for the bth compressed data cDTAb.

The ath memory device 112a may transmit and receive a command, an address, an ath compressed data cDTAa, an ath uncompressed data uDTAa, and a bth mapping data mDTAb through the ath channel CHa. The bth memory device 112b may transmit and receive the command, the address, the bth compressed data cDTAb, the bth uncompressed data uDTAb, and the ath mapping data mDTAa through the bth channel CHb, which is different from the ath channel CHa. According to an exemplary embodiment, the memory interface circuit 111e of the controller 111 may include data pins and address pins corresponding to the ath channel CHa and the bth channel CHb.

The ath memory device 112a may include an ath compressed data region CRa, an ath uncompressed data region URa, and an ath mapping data region MRa. The bth memory device 112b may include a bth compressed data region CRb, a bth uncompressed data region URa, and a bth mapping data region MRb.

The ath compressed data region CRa is a region where the ath compressed data cDTAa is stored, and the a_1th to a_nth compressed data cDTAa1 to cDTAan, which are the ath compressed data cDTAa, may be stored in the ath compressed data region CRa. The bth compressed data region CRb is a region where the bth compressed data cDTAb is stored, and the b_1th to b_mth compressed data cDTAb1 to cDTAbm, which are the bth compressed data cDTAb, may be stored in the bth compressed data region CRb.

The a_1th to a_nth compressed data cDTAa1 to cDTAan and the b_1th to b_mth compressed data cDTAb1 to cDTAbm may correspond to the first to nth compressed data CDTA1 to cDTAn of FIG. 7.

The ath uncompressed data region URa is a region where the ath uncompressed data uDTAa is stored, and the a_1th to a_xth uncompressed data uDTAa1 to uDTAax, which are the ath uncompressed data uDTAa, may be stored in the ath uncompressed data region URa. The bth uncompressed data region URb is a region where the bth uncompressed data uDTAa is stored, and the b_1th to b_yth uncompressed data uDTAb1 to uDTAby, which are the bth uncompressed data uDTAb, may be stored in the bth uncompressed data region URb.

The a_1th to a_xth uncompressed data uDTAa1 to uDTAax and the b_1th to b_yth uncompressed data uDTAb1 to uDTAby may correspond to the first to xth uncompressed data uDTA1 to uDTAx in FIG. 7.

The ath mapping data region MRa is a region where the bth mapping data mDTAb for the bth compressed data cDTAb is stored, and the b_1th to b-mth mapping data mDTAb1 to mDTAbm may be stored in the ath mapping data region MRa. The b_1th to b_mth mapping data mDTAb1 to mDTAbm may include mapping information for each of the b_1th to b_mth compressed data cDTAb1 to cDTAbm. The bth mapping data region MRb is a region where the ath mapping data mDTAa for the ath compressed data cDTAa is stored, and the a_1th to a_n-th mapping data mDTAa1 to mDTAan may be stored in the bth mapping data region MRb. The a_1th to a_nth mapping data mDTAa1 to mDTAan may include mapping information for each of the a_1th to a_nth compressed data cDTAa1 to cDTAan.

The a_1th to a_nth mapping data mDTAa1 to mDTAan and the b_1th to b_mth mapping data mDTAb1 to mDTAbm may correspond to the first to nth mapping data mDTA1 to mDTAn of FIG. 7.

According to an exemplary embodiment, the ath compressed data region CRa, the bth compressed data region CRb, the ath uncompressed data region URa, and the bth uncompressed data region URb are the confirmation region iRG, and may be a memory region corresponding to the memory capacity information MEMcap reported to the processor 101 in response to the confirmation request for the memory capacity information of the processor 101. According to an exemplary embodiment, the confirmation region iRG may be confirmed by the processor 101 through the provided memory capacity information MEMcap and managed as the system memory by the processor 101.

According to an exemplary embodiment, the ath mapping data region MRa and the bth mapping data region MRb are the reserved region resRG, and may be a memory region that is excluded in the report of processor 101 in response to the confirmation request for the memory capacity information of processor 101. According to an exemplary embodiment, the reserved region resRG is a memory region where the ath and bth mapping data mDTAa and mDTAb are exclusively stored, and may correspond to the reserved region resRG of FIG. 7.

Through the mapping data regions MRa and MRb of the memory devices 112a and 112b, the memory expander 110b may reduce or remove the need for a separate memory device storing the mapping data mDTA and a separate channel for the memory device, and the controller 111 may improve a physical overhead such as data pin and address pin arrangement required for the channel.

According to an exemplary embodiment, the memory expander 110b may separately store compressed data cDTA and mapping data mDTA for the compressed data cDTA through different channels CHa and CHb separate from each other, interleave the stored compressed data cDTA and mapping data mDTA, and simultaneously store the compressed data cDTA and mapping data mDTA. For example, the memory expander 110b may efficiently perform the access operation for the read or write operation in random writing or random reading for the plurality of compressed data cDTA through the above simultaneous access.

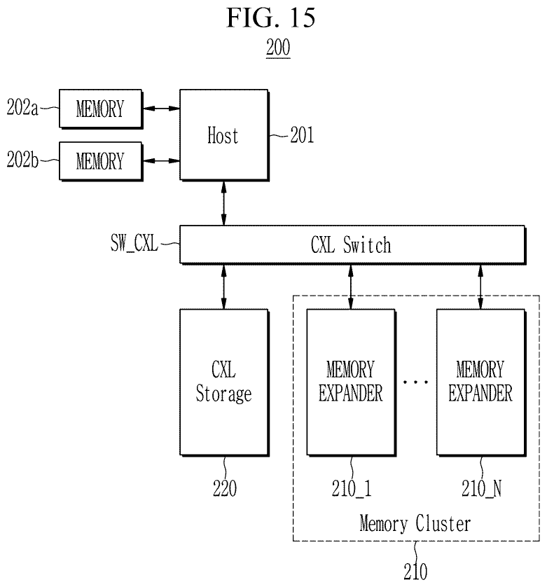

FIG. 15 is a block diagram illustrating an electronic device according to an exemplary embodiment. Hereinafter, for convenience of explanation, detailed descriptions of overlapping corresponding components may be omitted. Referring to FIG. 15, the electronic device 200 includes a host device 201, a plurality of memories 202a and 202b, a CXL switch SW_CXL, a plurality of CXL memory expanders 210_1 to 210_N, and CXL storage 220.

The host device 201 may be directly connected to a plurality of memories 202a and 202b. The host device 201, the plurality of CXL memory expanders 210_1-210_N, and the CXL storage 220 may be connected to a CXL switch SW_CXL, and each may communicate with each other through the CXL switch SW_CXL.

According to an exemplary embodiment, each of the plurality of CXL memory expanders 210_1-210_N may correspond to the memory expander 110 described with reference to FIGS. 1 to 14. For example, each of the plurality of CXL memory expanders 210_1-210_N may be implemented as an individual memory device or memory module, and may be connected to the CXL switch SW_CXL through different physical ports. By connecting the plurality of CXL memory expanders 210_1 to 210_N to the CXL switch SW_CXL, the memory region managed by the host device 201 may be increased in capacity.

Additionally, each of the plurality of CXL memory expanders 210_1 to 210_N may receive a compression request from the host device 201 and perform the compression operation according to the compression request. According to an exemplary embodiment, the plurality of CXL memory expanders 210_1 to 210_N may provide memory capacity information in response to a confirmation request for management of the host device 201, may exclude a portion of the memory from the provided memory capacity, and may store the mapping data according to the compression operation in a portion of the memory that is excluded from the provided memory capacity, thereby improving the physical overhead required for the channel, and improving the efficiency of the read operation for compressed data.

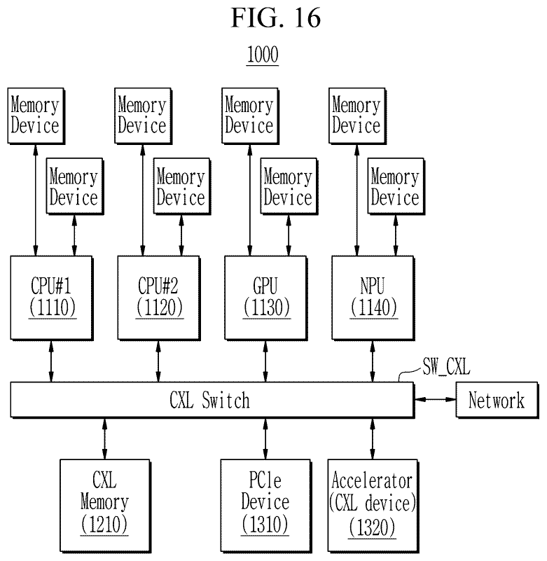

FIG. 16 is a block diagram illustrating a computing system to which a memory system according to an exemplary embodiment is applied. This is a block diagram illustrating a computing system according to an exemplary embodiment of the present disclosure. In the following, detailed descriptions of overlapping corresponding configurations may be omitted for better understanding and ease of description.

Referring to FIG. 16, the computing system 1000 includes a first CPU 1110, a second CPU 1120, a GPU 1130, an NPU 1140, a CXL switch SW_CXL, a CXL memory expander 1210, and a PCIe device 1310, and an accelerator (CXL device) 1320.

The first CPU 1110, the second CPU 1120, the GPU 1130, the NPU 1140, the CXL memory expander 1210, the PCIe device 1310, and the accelerator (CXL device) 1320 may be commonly connected to the CXL switch SW_CXL, and each may communicate with each other through the CXL switch SW_CXL.

According to an exemplary embodiment, each of the first CPU 1110, the second CPU 1120, the GPU 1130, and the NPU 1140 may be the processor 101 described with reference to FIGS. 1 to 14, and each may be directly connected to individual memories.

According to an exemplary embodiment, the CXL memory expander 1210 may be the memory expander 110 described with reference to FIGS. 1 to 14 and at least a portion of the area of the CXL memory expander 1210 may be allocated to the system memory of each of the first CPU 1110, the second CPU 1120, the GPU 1130, and the NPU 1140 by one or more of the first CPU 1110, the second CPU 1120, the GPU 1130, and the NPU 1140. For example, the CXL memory expander 1210 may support memory pooling technology for the first CPU 1110, the second CPU 1120, the GPU 1130, and the NPU 1140.

According to an exemplary embodiment, the CXL memory expander 1210 may receive a compression request from one or more of the first CPU 1110, the second CPU 1120, the GPU 1130, and the NPU 1140 and perform a compression operation in response to the compression request. According to an exemplary embodiment, the CXL memory expander 1210 may exclude a portion of the memory in the memory capacity information and provide it in response to the confirmation request for management of the first CPU 1110, the second CPU 1120, the GPU 1130, and the NPU 1140, store the mapping data according to the compression operation in a memory region corresponding to the excluded portion of the memory, in order to improve the physical overhead required for the channel, and improve the efficiency of the read operation for the compressed data.

In one exemplary embodiment, the CXL switch SW_CXL may be connected to a PCIe device 1310 or an accelerator 1320 configured to support various functions, and the PCIe device 1310 or accelerator 1320 may communicate with each of the first CPU 1110, second CPU 1120, GPU 1130, and NPU 1140 through the CXL switch SW_CXL and access the CXL memory expander 1220.

In one exemplary embodiment, the CXL switch SW_CXL may be connected to an external network or fabric, and may communicate with an external server through the external network or fabric.

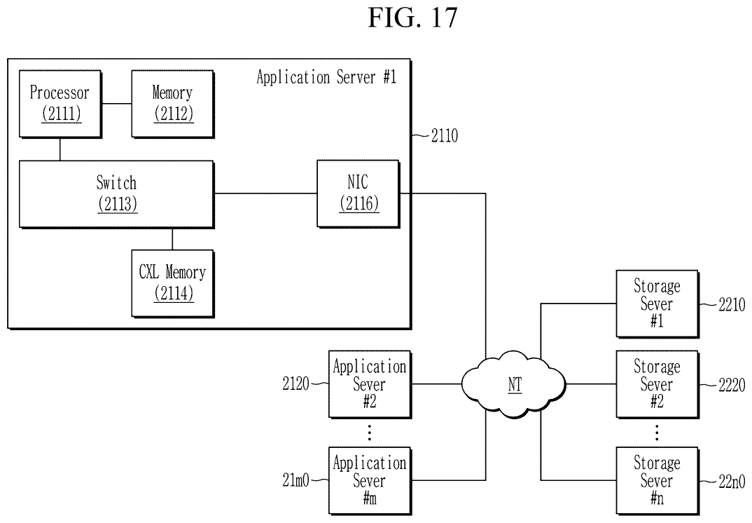

FIG. 17 is a block diagram illustrating a data center to which a memory system according to an exemplary embodiment is applied.

Referring to FIG. 17, the data center 2000 is a facility that collects various data and provides services, and may also be referred to as a data storage center. The data center 2000 may be a system for operating a search engine and database, or may be a computing system used by companies such as banks or government agencies. The data center 2000 may include a plurality of application servers 2110 to 21m0 and a plurality of storage servers 2210 to 22n0. The number of application servers and the number of storage servers may be selected variously according to the exemplary embodiment, and the number of application servers and the number of storage servers may be different.

Hereinafter, the description will focus on the configuration of the first application server 2110. Each of the plurality of application servers 2110 to 21m0 and the plurality of storage servers 2210 to 22m0 may have a structure similar to each other, and the plurality of application servers 2110 to 21m0 and the plurality of storage servers 2210 to 22m0 may communicate with each other through the network NT.

The first application server 2110 may include a processor 2111, a memory 2112, a switch 2113, a CXL memory expander 2114, and a network interface card (NIC) 2116. The processor 2111 may control the overall operation of the first application server 2110 and may access the memory 2112 to execute instructions loaded into the memory 2112 or process data. The memory 2112 may be Double Data Rate Synchronous DRAM (DDR SDRAM), High Bandwidth Memory (HBM), Hybrid Memory Cube (HMC), Dual In-line Memory Module (DIMM), Optane DIMM, and/or Non-Volatile DIMM (NVMDIMM). The processor 2111 and the memory 2112 may be directly connected, and the number of processors 2111 and the number of memories 2112 included in one first application server 2110 may be selected variously.

According to an exemplary embodiment, the processor 2111 and the memory 2112 may provide a processor-memory pair. In an exemplary embodiment, the number of processors 2111 and memories 2112 may be different. The processor 2111 may include a single core processor or a multi-core processor. The above description of the first application server 2110 may be similarly applied to each of the plurality of storage servers 2110 to 21m0.

The switch 2113 may be configured to mediate or route communication between various components included in the first application server 2110. According to an exemplary embodiment, the switch 2113 may be the CXL interface described in FIGS. 1 to 14. For example, the switch 2113 may be a switch implemented based on the CXL protocol.

The CXL memory expander 2114 may be connected to the switch 2113. According to an exemplary embodiment, the CXL memory expander 2114 may be used as the memory expander for the processor 2111. A portion of the CXL memory expander 2114 may be allocated as system memory of the processor 2111, as described with reference to FIGS. 1 to 14.

According to an exemplary embodiment, the CXL memory expander 2114 may receive a compression request for the processor 2111 and perform a compression operation according to the compression request. According to an exemplary embodiment, the CXL memory expander 2114 may exclude part of the memory in the memory capacity information and provide it in response to the confirmation request for management of the processor 2111, and store mapping data according to the compression operation in the part of the memory excluded from the memory capacity information, in order to improve the physical overhead required for the channel, and improve the efficiency of the read operation for the compressed data.

Although not shown, according to an exemplary embodiment, the plurality of application servers 2110 to 21m0 may include a storage device. The plurality of storage servers 2210 to 22n0 may include at least one storage device. The number of storage devices included in the plurality of storage servers 2210 to 22n0 may be selected in various ways according to the exemplary embodiment.

A network interface card (NIC) 2116 may be connected to the CXL switch SW_CXL. The NIC 2116 may communicate with a plurality of other application servers 2110 to 21m0 or other storage servers 2220 to 22n0 through the network NT.

According to an exemplary embodiment, the NIC 2116 may include a network interface card, a network adapter, etc. The NIC 2116 may be connected to the network NT by a wired interface, a wireless interface, a Bluetooth interface, an optical interface, etc. The NIC 2116 may include internal memory, a digital signal processor (DSP), a host bus interface, etc., and may be connected to the processor 2111 and/or the switch 2113 through the host bus interface. According to an exemplary embodiment, the NIC 2116 may be integrated with at least one of the processor 2111, the switch 2113, and the CXL memory expander 2114.

In one exemplary embodiment, the network NT may be implemented using a fiber channel (FC), Ethernet, etc. In this case, the FC is a medium used for relatively high-speed data transmission, and may use an optical switch that provides high performance/high availability. Depending on the network NT access method, the storage servers may be provided as file storage, block storage, or object storage.

In one exemplary embodiment, the network NT may be a storage-only network, such as a storage region network (SAN). For example, the SAN may be an FC-SAN that uses an FC network and is implemented according to the FC Protocol (FCP). As another example, the SAN may be an IP-SAN that uses a TCP/IP network and is implemented according to the iSCSI (SCSI over TCP/IP or Internet SCSI) protocol. In one exemplary embodiment, the network NT may be a general network such as a TCP/IP network. For example, the network NT may be implemented according to protocols such as FC over Ethernet (FCOE), Network Attached Storage (NAS), and NVMe over Fabrics (NVMe-oF).

In one exemplary embodiment, at least one of the plurality of application servers 2110 to 21m0 may store data requested to be stored by a user or client in one of the plurality of storage servers 2210 to 22n0 through the network NT. At least one of the plurality of application servers 2110 to 21m0 may obtain data requested to be read by a user or client from one of the plurality of storage servers 2210-22n0 through the network NT. For example, at least one of the plurality of application servers 2110 to 21m0 may be implemented as a web server, a Database Management System (DBMS), etc.

In one exemplary embodiment, at least one of the plurality of application servers 2110 to 21m0 may access memory, a CXL memory expander, or a storage device included in another application server through the network NT, or access the memory, the CXL memory expander, or the storage device included in the plurality of storage server 2210 to 22n0 through the network NT. Accordingly, at least one of the plurality of application servers 2110 to 21m0 may perform various operations on data stored in other application servers and/or storage servers. For example, at least one of the plurality of application servers 2110 to 21m0 may execute instructions to move or copy data between the plurality of other application servers and/or the plurality of other storage servers. In this case, data may be moved from the storage device of the plurality of storage servers through the memory or CXL memory expander of the plurality of storage servers, or directly to the memory or CXL memory expander of the plurality of application servers. The data moving over a network may be encrypted for security or privacy.

Although embodiments of the present invention have been described in detail hereinabove, the scope of the present invention is not limited thereto, but may include several modifications and alterations made by those skilled in the art using a basic concept of the present invention as defined in the claims.

What is claimed is:

1. A memory expander, comprising:
a controller configured to perform a compression operation on data received from outside of the memory expander to generate compressed data and generate mapping data including a device physical address for the compressed data; and
a first memory device including a volatile memory that is connected to the controller through a first channel and includes a first mapping data region where the mapping data is stored and a first compressed data region where the compressed data is stored.

2. The memory expander of claim 1, wherein:
the volatile memory is a dynamic random-access memory (DRAM).

3. The memory expander of claim 1, wherein:
the controller includes a Compute express Link (CXL) interface configured to receive the data.

4. The memory expander of claim 3, wherein:
the CXL interface includes a host-managed device memory (HDM) decoder configured to map a host physical address received from outside of the memory expander and a memory region of the volatile memory, and
the controller is configured to access the first compressed data region through the HDM decoder.

5. The memory expander of claim 1, wherein:
the device physical address includes a bank address and a row address corresponding to the first compressed data region, and column start information and column end information in the row address, and
a size of the mapping data is 8 bytes or 16 bytes.

6. The memory expander of claim 1, wherein:
the data includes first and second data different from each other,
the compressed data includes first compressed data for the first data and second compressed data for the second data,
the mapping data includes first mapping data including a first device physical address of the first compressed data and second mapping data including a second device physical address of the second compressed data, and
the first memory device is configured to read the first compressed data based on the first mapping data and read the second compressed data based on the second mapping data.

7. The memory expander of claim 6, wherein:
the first memory device includes a plurality of banks that include a first and second bank different from each other,
the mapping data is stored in at least a portion of the first bank, and
the compressed data is stored in the plurality of banks other than the first bank.

8. The memory expander of claim 7, wherein:
the first memory device is configured to provide the first compressed data and the second mapping data in an interleaving manner.

9. The memory expander of claim 6, wherein:
the first memory device includes a plurality of banks that include a first bank and a second bank different from each other, and
the mapping data is stored in a predetermined row of each of the first bank and the second bank.

10. The memory expander of claim 9, wherein:
the first and second mapping data are stored in the first bank, and
the controller is configured such that when the first mapping data is read, the controller prefetches the second mapping data.

11. The memory expander of claim 6, further comprising:
a second memory device connected to the controller through a second channel different from the first channel and including a second mapping data region where the mapping data is stored and a second compressed data region where the compressed data is stored,
the first compressed data is stored in the first compressed data region,
the second compressed data is stored in the second compressed data region,
the second mapping data is stored in the first mapping data region, and
the first mapping data is stored in the second mapping data region.

12. The memory expander of claim 1, wherein:
the data includes first and second data different from each other,
the controller is configured to receive the first and second data to generate first compressed data for the first data,
the first compressed data is stored in the first compressed data region,
the first memory device further includes a first uncompressed data region where the second data is stored.

13. The memory expander of claim 12, wherein:
a size of the first data is 4 KB,
a size of the second data is 4 KB, and
a size of the first compressed data is 1 KB.

14. An electronic device, comprising:
a processor configured to generate a confirmation request requesting memory capacity information and a compression request for a host physical address and data of the host physical address, and provide the confirmation request and the compression request through a CXL interface; and
a memory expander including a memory device and configured to:
provide memory capacity information corresponding to a first region of the memory device, which is some of the overall memory capacity of the memory device, to the processor in response to the confirmation request provided from the processor, and
generate compressed data for the data and mapping data including the host physical address in response to the compressed request,
wherein the memory device is a DRAM in which the compressed data and the mapping data are stored.

15. The electronic device of claim 14, wherein:
the memory expander further includes a controller configured to generate the compressed data and the mapping data, and
the memory device is connected to the controller through a first channel and includes a first region where the compressed data is stored and a second region where the mapping data is stored.

16. The electronic device of claim 15, wherein:
a size of the second region is 256 MB.

17. The electronic device of claim 14, wherein:
the compression request is a CXL protocol-based Master to Subordinate Request with Data (M2S RwD) message.

18. A method of operating an electronic device, comprising:
providing a confirmation request requesting memory capacity information to a memory expander including a dynamic random-access memory (DRAM):
providing memory capacity information corresponding to a first region, which is part of a memory device included in the memory expander, to a processor in response to the confirmation request;
allocating a compressed data region and an uncompressed data region within the first region;
generating compressed data and mapping data including a host physical address,) in response to a compression request for data from the processor; and
performing a write operation on the compressed data in the compressed data region and performing a write operation on the mapping data in a second region different from the first region within the memory device.

19. The method of claim 18, wherein:
the memory expander further includes a controller configured to generate the compressed data and the mapping data, and
the memory device is configured to receive the compressed data and the mapping data through a first channel.

20. The method of claim 18, wherein:
the compressed data includes first compressed data and second compressed data that are different from each other,
the mapping data includes first mapping data for the first compressed data and second mapping data for the second compressed data,
the memory expander further includes a controller configured to generate the first and second compressed data and the first and second mapping data, and
the memory device includes a first memory device configured to receive the first compressed data and the second mapping data through a first channel, and a second memory device configured to receive the second compressed data and the first mapping data through a second channel different from the first channel.
